(19) United States
(12) Patent Application Publication
(10) Pub. No.: US 2013/0125642 A1
(43) Pub. Date: May 23, 2013

(54) SENSOR DEVICE FOR A DOWN HOLE SURVEYING TOOL

(71) Applicant: Richard John Parfitt, Lewes (GB)

(72) Inventor: Richard John Parfitt, Lewes (GB)

(73) Assignee: IMDEX TECHNOLOGY AUSTRALIA PTY LTD., Osborne Park, Western Australia (AU)

(21) Appl. No.: 13/699,670

(22) PCT Filed: May 25, 2011
(86) PCT No.: PCT/AU2011/000632

§ 371 Date: Feb. 4, 2013

(30) Foreign Application Priority Data
May 25, 2010 (AU) 2010902279

(51) Int. Cl. E21B 47/00; G01C 19/00

(52) U.S. Cl. CPC E21B 47/00; G01C 19/00
USPC 73/152.54; 73/504.02

(57) ABSTRACT

A down hole surveying tool (10) is for directional surveying of boreholes. The tool (10) includes a body (11) which accommodates a composite sensor device (17). The sensor device (17) is supported for rotation about an indexing axis (4) in a rotary mount (31) which provides an indexing platform (33). The sensor device (17) can be indexed about the indexing axis between two indexing positions which are 180 degrees apart. An indexing mechanism (70) is provided for selectively indexing the sensor device (17) about the indexing axis (4). The sensor device (17) includes a two-axis gyroscope (13) and a two-axis accelerometer (15) connected together and rotatable in unison. The indexing axis (4) is perpendicular to the two sensitive axes of the gyroscope (13) and the two sensitive axes of the accelerometer (15). The gyroscope (13) and accelerometer (15) are rigidly fixed with respect to each other to provide a sensor package which constitutes the composite sensor device (17).

### FIELD OF THE INVENTION

This invention relates to sensor device for down hole surveying and also to a down hole survey tool incorporating such a sensor device. The invention also relates to a method of performing a down hole surveying operation.

### BACKGROUND ART

The following discussion of the background art is intended to facilitate an understanding of the present invention only. The discussion is not an acknowledgement or admission that any of the material referred to is or was part of the common general knowledge as at the priority date of the application.

During a borehole drilling operation there is a need to survey the path of the borehole to determine if the trajectory is being maintained within acceptable limits. Surveying a borehole is usually accomplished using a survey tool which is moved along the borehole to obtain the information required, or at least data from which the required information can be determined. Information in relation the path of a borehole can typically include inclination, azimuth and depth.

Surveying tools typically contain sensor devices for measuring the direction and magnitude of the local gravitational field, and also the rate of rotation of the Earth. These measurements correspond to the position and orientation of the surveying tool in the borehole. The position, inclination and/or azimuth can be calculated from these measurements.

The sensor devices can comprise accelerometers for measuring the direction and magnitude of the local gravitational field, and gyroscopes for measuring the rate of rotation of the Earth, from which azimuth can be calculated.

Commercially available gyroscopes contain systematic errors which can seriously affect the accuracy of measurement.

With a view to eliminating, or at least reducing the systematic errors, it is known to index gyroscopes through 180 degrees between two indexing positions, with measurements being taken at the two indexing positions. Because the indexing positions are 180 degrees apart, the measurements will be reversed; that is, the measurements deliver the same data but with reversed polarity. With these measurements, the systematic errors can be eliminated or diminished.

Commercially available accelerometers also contain systematic errors which can be handled in a similar way.

In order to index sensor devices, such as gyroscopes and/or accelerometers, between various indexing positions, there is a need for an indexing mechanism aboard the surveying tool.

There is also a need to orient the sensor devices so that two orthogonal sensitive axes occupy a selected plane, which typically is horizontal.

The need to index and orient the sensor devices can introduce cost and complexity to the surveying tool, and can be particularly problematic where a survey tooling of compact construction is required.

The present invention seeks to provide an arrangement involving both a gyroscope and an accelerometer which can be oriented and indexed in unison.

### DISCLOSURE OF THE INVENTION

According to a first aspect of the invention there is provided a sensor device comprising a gyroscope and an accelerometer connected together and rotatable in unison about an axis perpendicular to two sensitive axes of the gyroscope and two sensitive axes of the accelerometer.

The sensor device may comprise a two-axis gyroscope and a two-axis accelerometer, with the respective sensitive axes perpendicular to the indexing axis.

According to a second aspect of the invention there is provided a down hole surveying tool incorporating a sensor device according to a first aspect of the invention.

According to a third aspect of the invention there is provided a down hole surveying tool comprising a sensor device rotatable about an indexing axis, a base, a support for supporting the sensor device for rotation about the indexing axis, the support comprising a rotary mount supported on the base for rotation about a pitch axis transverse to the indexing axis, a pitch drive mechanism for selectively rotating the rotary mount about the pitch axis, and an indexing drive mechanism for indexing the sensor device about the indexing axis, the sensor device comprising a gyroscope and an accelerometer connected together and rotatable in unison, the indexing axis being perpendicular to two sensitive axes of the gyroscope and two sensitive axes of the accelerometer.

The indexing drive mechanism may comprise a drive portion and a driven portion, the drive portion being provided on the base and the driven portion being provided on the rotary mount and drivingly connected to sensor device, the driven portion being movable into and out of engagement with the drive portion upon rotation of the rotary mount about the pitch axis, whereby when the driven portion is in engagement with the drive portion it can receive drive therefrom to cause indexing of the sensor device about the indexing axis.

According to a fourth aspect of the invention there is provided a method of performing a down hole survey operation using a down hole surveying tool according to the second or third aspect of the invention.

According to a fifth aspect of the invention there is provided a method of performing a down hole survey operation comprising: positioning a survey tool at a selected location within a borehole, the survey tool having a sensor device with at least two sensitive axes; orienting the sensor device such that the two sensitive axes occupy a selected plane; obtaining a measurement from the sensor device at the selected location; moving the sensor device into an indexing position at which the sensor device can be indexed about an indexing axis perpendicular to the two sensitive axes; returning the indexed sensor device to the position at which the two sensitive axes occupied the selected plane; and obtaining a further measurement from the sensor device at the selected location.

The method may further comprise sequentially positioning the survey tool at one or more further selected locations within the borehole; orienting the sensor device such that the two sensitive axes occupy a selected plane at the further selected location; obtaining a measurement from the sensor device at the further selected location; moving the sensor device into an indexing position at which the sensor device can be indexed about an indexing axis perpendicular to the two sensitive axes; returning the indexed sensor device to the position at which the two sensitive axes occupied the selected plane at the further selected location; and obtaining a further measurement from the sensor device at the further selected location.

### BRIEF DESCRIPTION OF THE DRAWINGS

The invention will be better understood by reference to the following description of one specific embodiment thereof as shown in the accompanying drawings in which:

FIG. 1 is a perspective view of a down hole surveying tool incorporating a composite sensor device according to the embodiment, with part of the exterior housing of the tool removed to reveal internal features;

FIG. 2 is a view similar to FIG. 1 but with further parts removed to reveal additional internal features;

FIG. 3 is schematic plan view of a rotary mount for the sensor device which is movable between two indexing positions, the rotary mount being configured as an indexing platform and an indexing mechanism operable in conjunction with the indexing platform;

FIG. 4 is a side view of the arrangement shown in FIG. 3;

FIG. 5 is perspective view of the indexing platform and the indexing mechanism, with the indexing platform shown in a first position;

FIG. 6 is a view similar to FIG. 5, except that the indexing platform is shown rotated into a second position for operation of the indexing mechanism;

FIG. 7 is a further perspective view, illustrating in particular the indexing mechanism;

FIG. 8 is a further perspective view, illustrating in particular the indexing platform and the drive portion of the indexing mechanism;

FIG. 9 is a further perspective view of the indexing platform, illustrating in particular a biasing means for biasing the sensor device into the respective indexing positions;

FIG. 10 is a further view of the indexing platform illustrating the biasing means;

FIGS. 11, 12 ad 13 are a series of views illustrating the indexing operation;

FIG. 14 is a schematic plan view of the indexing platform, a sensor device rotatably supported by the platform and a flexible connecting cable extending between the sensor device and the platform to provide electrical connectivity therebetween, with the sensor device shown in a first indexed position;

FIG. 15 is a view similar to FIG. 14, except that the sensor device is shown in a second indexed position;

FIG. 16 is a sectional view further illustrating the indexing platform, the sensor device, and the flexible connecting cable extending between the sensor device and the platform;

FIG. 17 is a perspective view illustrating the indexing platform, the sensor device, and the flexible connecting cable extending between the sensor device and the platform;

FIG. 18 is a schematic side view of the indexing platform, and a flexible connecting cable extending from the platform to provide electrical connectivity with electrical circuitry elsewhere within the tool, with the indexing platform shown in one rotational position;

FIG. 19 is a view similar to FIG. 18, except that the indexing platform is shown in another rotational position;

FIG. 20 is a perspective view of the down hole surveying tool, illustrating in particular the indexing platform, and the flexible connecting cable extending from the platform to provide electrical connectivity with electrical circuitry elsewhere within the tool;

FIG. 21 is a schematic view of an optical alignment system for sensing alignment between drive portion and the driven portion of the indexing mechanism, the driven portion, which is mounted on the indexing platform, being shown in a first indexed position;

FIG. 22 is a view similar to FIG. 21, except that the driven portion is shown in a second indexed position;

FIG. 23 is a sectional view of the indexing platform, illustrating in particular the driven portion and that part of the optical alignment system provided thereon;

FIG. 24 is a perspective view of part of the base of the down hole surveying tool, illustrating in particular the drive portion and that part of the optical alignment system provided thereon;

FIG. 25 is a schematic view of a composite sensor device according to the embodiment used in the down hole surveying tool; and

FIG. 26 is a sectional perspective view of the indexing platform, illustrating in particular the composite sensor device supported therein.

### BEST MODE(S) FOR CARRYING OUT THE INVENTION

Referring to the drawings, there is shown a down hole surveying system 10 for directional surveying of boreholes. The down hole surveying system tool 10 is configured as a tool which, for convenience, is also denoted by the same reference numeral 10.

The tool 10 incorporates a composite sensor device according to the embodiment.

The tool 10 comprises a body 11 which is sized and shaped for movement along a borehole in down hole surveying applications where the maximum passage diameter is typically about 45 mm.

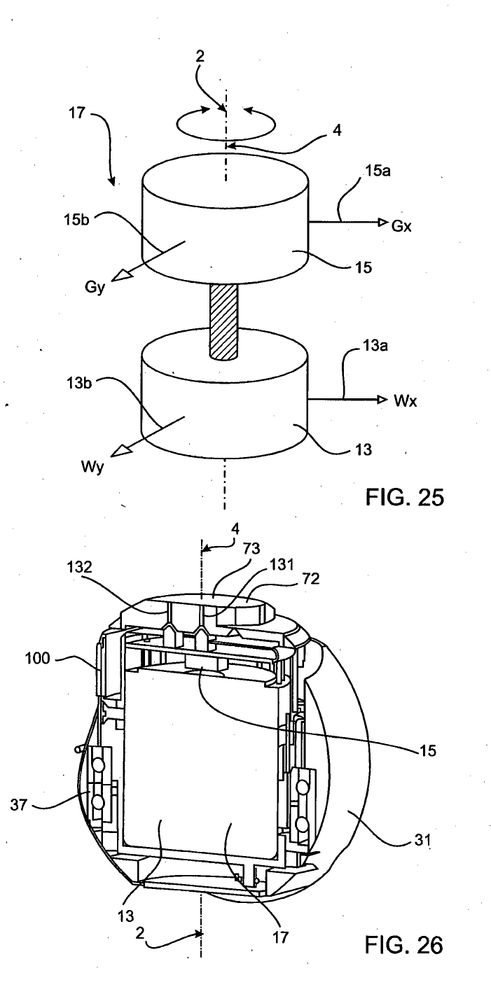

The body 11 accommodates a single mechanical gyroscope 13 and a single accelerometer 15. The gyroscope 13 and accelerometer 15 are rigidly fixed with respect to each other to provide a sensor package which will hereinafter be referred to as a composite sensor device 17 according to the embodiment. In this embodiment, the gyroscope 13 is a two-axis gyroscope and the accelerometer 15 is a two-axis accelerometer, as illustrated in FIGS. 25 and 26. The two sensitive axes for the gyroscope 13 are identified in FIG. 25 by reference numerals 13a and 13b. Similarly, the two sensitive axes for the accelerometer 15 are identified in FIG. 25 by reference numerals 15a and 15b.

The tool 10 is configured for selectively rotating the sensor device 17 about first and second mutually perpendicular axes 1, 2; which for convenience will be referred to pitch and yaw axes respectively. The first and second axes 1, 2 are shown in FIG. 2.

The body 11 has a longitudinal axis 3 about which it can roll, which will be referred to as the roll axis. When the tool 10 is down the borehole, the roll axis 3 is aligned with the longitudinal extent of the adjacent section of the borehole in which the tool 10 is located at any particular time.

The yaw axis 2 is perpendicular to the sensitive axes of the two-axis gyroscope 13 and the two-axis accelerometer 15.

Rotation about the pitch and roll axes 1, 3 allow the respective planes of the sensitive axes of the gyroscope 13 and accelerometer 15 to be aligned as required. In this embodiment, the gyroscope 13 and accelerometer 15 are required to be moved into sensing positions in which their respective sensitive axes occupy horizontal planes.

Rotation about the yaw axis 2 allows indexation of the gyroscope 13 and the accelerometer 15 through various indexing positions, with a consequent reduction or cancellation of systematic errors in both devices. Specifically, the sensor device 17 is selectively rotatable about the yaw axis 2 between various indexing positions, as will be explained in more detail later. In this embodiment, the sensor device 17 is rotatable about the yaw axis 2 between two indexing positions which are 180 degrees apart.

While not shown in the drawings, a drive mechanism is provided for varying the roll angle of the housing 29 within the borehole; that is, for rotating the housing 29 about the roll axis 3.

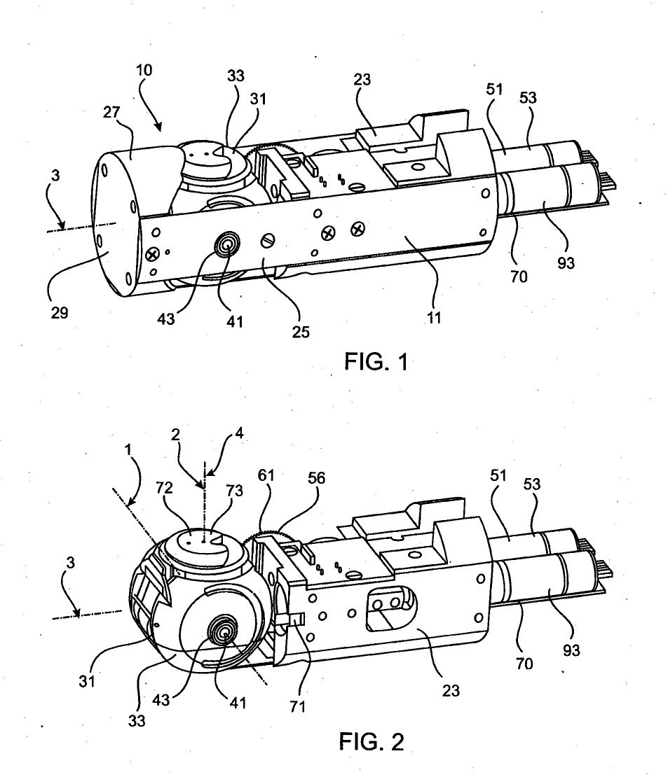

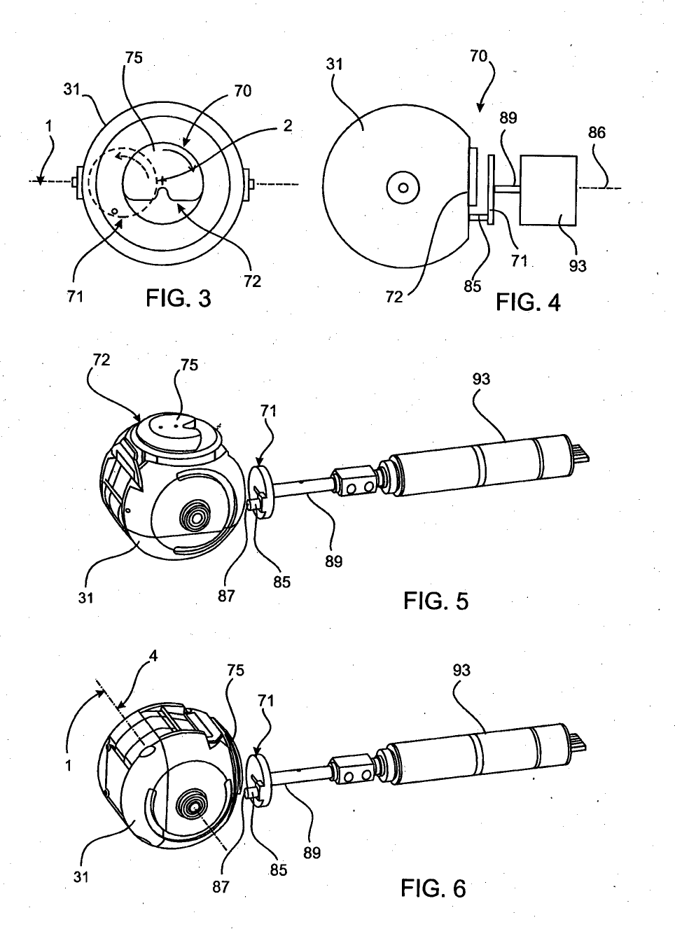

The body 11 comprises a base 23, two side members 25 and a cover 27 forming a housing 29. The cover 27 is shown partly cut-away in FIG. 1, and the two side members 25 and cover 27 are removed from FIG. 2 to reveal internal parts.

The sensor device 17 is supported in a rotary mount 31 accommodated within the housing 29. The rotary mount 31 is configured as spherical indexing platform 33 in which the sensor device 17 is supported for rotation about the yaw axis 2. With this arrangement, the yaw axis 2 defines an indexing axis 4 about which the sensor device 17 can be indexed, as will be explained later. Accordingly, the various sensitive axes of the the gyroscope 13 and accelerometer 15 are substantially perpendicular to the indexing axis 4, as shown in FIG. 25.

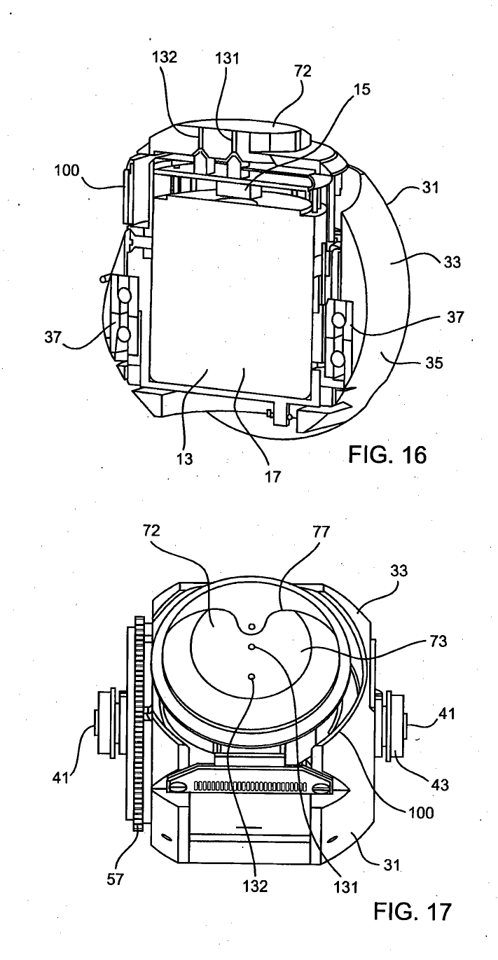

The indexing platform 33 comprises a hollow body 35 in which the sensor device 17 is rotatably supported, as best seen in FIG. 16. The gyroscope 13 is rotatably supported in a pair of pre-loaded bearings 37 located between the gyroscope 13 and the hollow body 35.

The indexing platform 33 is supported within the housing 29 for rotation about the pitch axis 1 which is transverse to the indexing axis 4. In the arrangement illustrated, the indexing platform 33 has two stub axles 41 having axes which cooperate to provide the pitch axis 1. The stub axles 41 are rotatably supported in bearings 43 mounted in the side members 25.

A pitch drive mechanism 51 is provided for selectively rotating the indexing platform 33 about the pitch axis 1. This allows the sensor device 17 to be rotated into any selected plane about the pitch axis 1 for sensing purposes.

The pitch drive mechanism 51 comprises a pitch drive motor 53 drivingly coupled to the indexing platform 33. The pitch drive motor 53 is drivingly coupled to the indexing platform 33 through a drive transmission 56 comprising a ring gear 57 mounted on the indexing platform 33 coincidently with the pitch axis 1. The drive transmission 56 further comprises a drive shaft (not shown) and a drive pinion 61 which is rigidly mounted on the drive shaft and which is in meshing engagement with the ring gear 57. With this arrangement, the indexing platform 33 can be selectively caused to undergo pitch rotation about the pitch axis 1 by actuation of the drive motor 53, the direction of pitch rotation being determined by the direction of rotation of the drive motor.

An indexing mechanism 70 is provided for selectively indexing the sensor device 17 about the indexing axis 4. As mentioned earlier, in this embodiment, the sensor device 17 is rotatable about the indexing axis 4 between two indexing positions which are 180 degrees apart.

The indexing mechanism 70 comprises a drive portion 71 and a driven portion 72 adapted for selective interaction to impart indexing motion to the sensor device 17.

The driven portion 72 comprises an indexing head 73 rotatably mounted on the indexing platform 33 and connected to the sensor device 17. The indexing head 73 comprises an indexing plate 75 configured to define a cam profile 77 presenting a cam face 79. The cam profile 77 is configured to define a recess 81 and two lobes 83 on opposed sides of the recess.

The drive portion 71 comprises a drive element 85 adapted to impart rotation to the indexing plate 75. The drive element 85 is mounted eccentrically for rotation about a drive axis 86. The drive element 85 comprises a drive pin 87 provided at one end of a drive shaft 89 having an axis of rotation corresponding to the drive axis 86. The drive pin 87 is configured as a roller pin. The drive shaft 89 is configured as a crank, with the drive pin 87 offset from the axis of rotation of the drive shaft. The drive portion 71 further comprises an indexing drive motor 93 drivingly coupled to the drive shaft 89 for selectively rotating the drive shaft about the drive axis 86 in either direction. Upon rotation of the drive shaft 89, the eccentric drive pin 87 is caused to move laterally through a circular path about the drive axis 86, the purpose of which will be explained later. The drive pin 87 has a “parked” position which it occupies when not in operation. The drive pin is shown in the “parked” position in FIGS. 5 and 6.

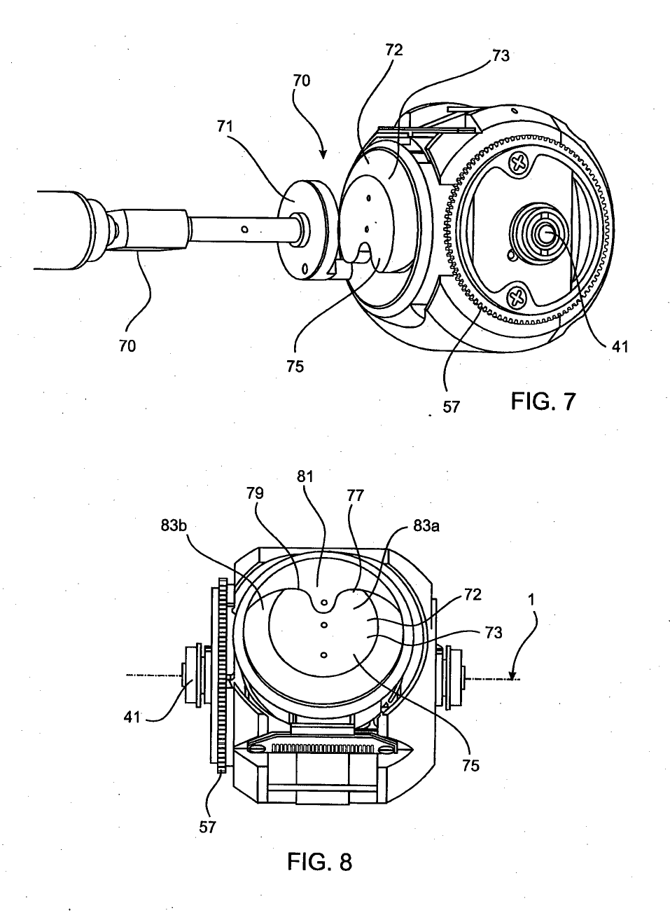

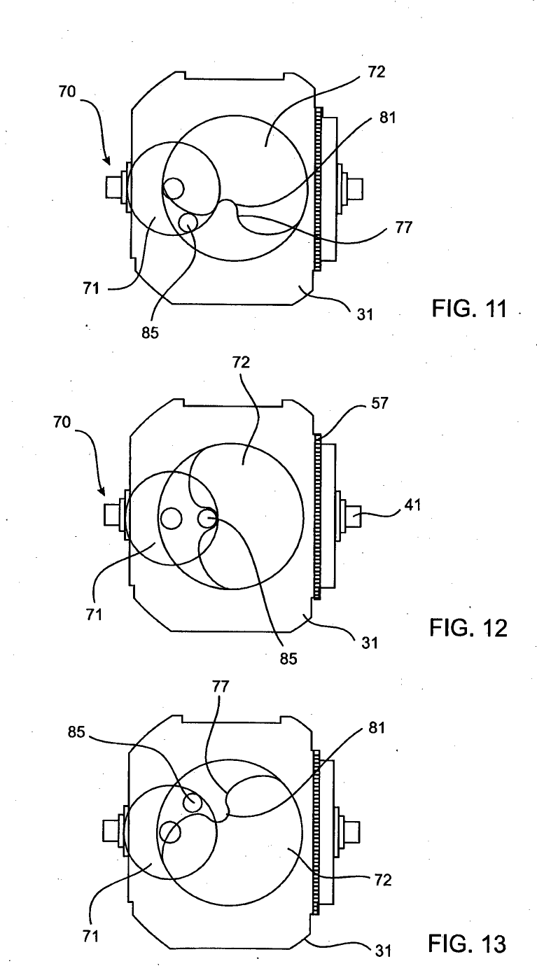

The indexing plate 75 and the drive pin 87 are adapted to cooperate to facilitate indexing of the sensor device 17 about the indexing axis 4 upon actuation of the indexing drive motor 93. Such cooperation involves rotation of the indexing platform 33 about the pitch axis 1, thereby moving the indexing head 73 towards the drive portion 71 into an operative position, as shown in FIGS. 4 to 7 and FIGS. 9 to 11. At this stage, the axis of rotation of the indexing plate 75 (which corresponds to the indexing axis 4) is parallel to the axis of rotation 91 of the drive shaft 89. With this arrangement, subsequent rotation of the drive shaft 89 under the action of the indexing drive motor 93 causes the drive pin 87 to leave its “parked” position and move laterally through a circular path about the drive axis 86 in the direction corresponding to the direction of rotation of the drive shaft 89. The moving drive pin 87 engages against the cam profile 77 of the indexing plate 75. Interaction between the moving drive pin 87 and the cam profile 77 causes the indexing plate 75 to rotate about its axis of rotation (which corresponds to the indexing axis 4). This causes the sensor device 17 to commence to index about the indexing axis 4. More particularly, the indexing action is initiated by interaction between the laterally moving drive pin 87 and the indexing plate 75, and is completed under the influence of an over-centre biasing mechanism 94 as will be described later.

The drive pin 87 continues to move through the circular path and ultimately returns to the “parked” position, awaiting the next indexing action.

With this arrangement, one complete rotation of the drive shaft 89 causes indexing through 180 degrees from one indexing position to the other.

Once the sensor device 17 has been indexed, the pitch drive mechanism 51 can be actuated to rotate the indexing platform 33 about the pitch axis 1 and restore the sensor device to its original position to continue sensing in the correct plane.

The direction of indexing is, of course, controlled by the direction of rotation of the drive shaft 89 under the influence of the indexing drive motor 93.

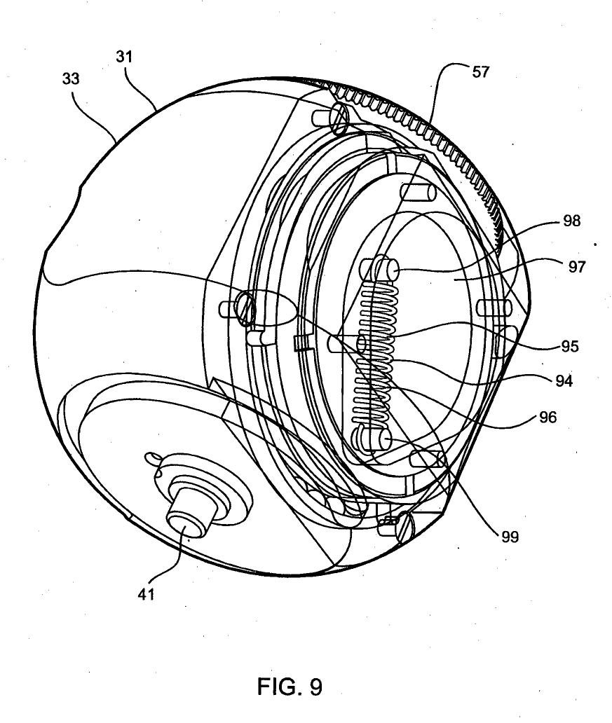

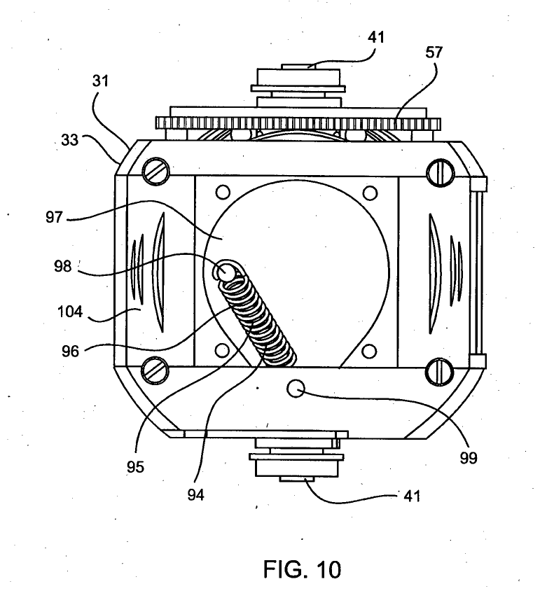

The over-centre biasing mechanism 94, which is shown in FIGS. 9 and 10, is operable to bias the sensor device 17 into the respective indexing positions. The over-centre biasing mechanism 94 comprises a bistable spring mechanism 95 which can pass through an over-centre position to bias the sensor device 17 into the respective indexing position. The bistable spring mechanism 95 is operably coupled to the sensor device 17 and is located on the indexing platform 33 in opposed relation to the indexing head 73.

The bistable spring mechanism 95 comprises a spring 96, and an end plate 97 rotatable in unison with the sensor device 17. One end of the spring 96 is connected to an eccentric pin 98 on the end plate 97 and the other end of the spring 96 is connected to fixed pin 99 mounted on a part of the hollow body 35 in which the sensor device 17 is rotatably supported.

A limit mechanism 104 is provided for limiting the extent of rotation of the sensor device 17 to the two indexing positions, 180 degrees apart.

As the sensor device 17 moves from one indexing position to the other, the spring 96 initially expands during movement away from the one indexing position until reaching the over-centre position and then contacts during movement towards the other indexing position after passing through the over-centre position. In this way, the bistable spring mechanism 95 functions to bias the sensor device 17 into the respective indexing position.

It is necessary to align the indexing platform 33 with respect to the drive pin 87 prior to actuation of the indexing mechanism 71. Specifically, it is necessary to align the pitch of the indexing platform 33 prior to indexing so that the indexing plate 75 is presented correctly to the drive pin 87. An optical alignment system 130 is provided for this purpose, as will be described in detail later.

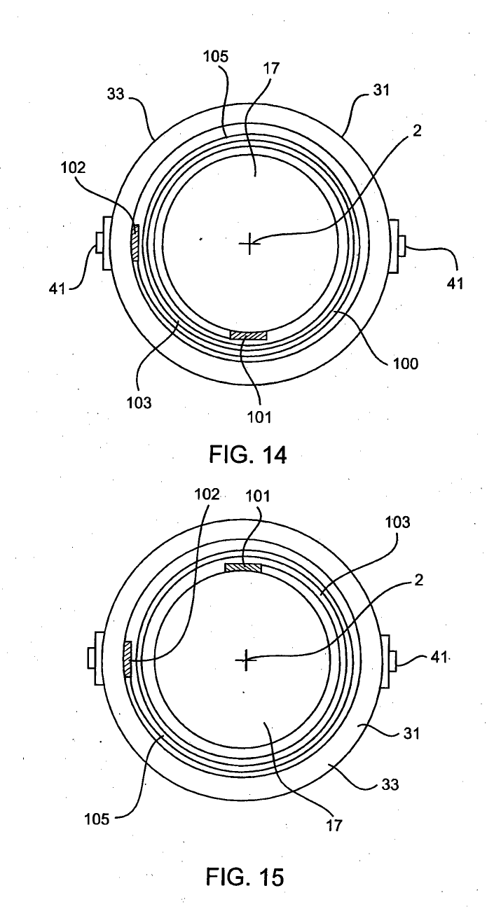

As mentioned above, the sensor device 17 is rotatable within the indexing platform 33 between the indexing positions. There is a need to establish an electrical connection between the sensor device 17 and the indexing platform 33 accommodating relative movement therebetween as the sensor device 17 indexes. For this purpose, a flexible connecting cable 100 extends between the sensor device 17 and the indexing platform 33, with one end section 101 of the cable 100 connected to the sensor device 17, the other end section 102 connected to the indexing platform 33 and the intermediate section 103 coiled about the indexing axis 4. With this arrangement, the cable 100 is accommodated in the space 105 between the sensor device 17 and the indexing platform 33, as best seen in FIGS. 14 to 17. The intermediate section 103 is coiled several times to accommodate the relative rotational movement without adversely stressing the cable 100 and affecting its service life. In the arrangement illustrated, the cable 100 comprises a flat multi-core cable to provide a compact arrangement.

As the sensor device 17 rotates from one indexing position to another, the coiled intermediate section 103 simply winds and unwinds according to the direction of movement, with electrical connectivity being maintained at all times.

Such an arrangement provides a simple yet highly effective electrical connection between the sensor device 17 and the rotary mount 3, which is compact and which obviates the need for a conventional slip ring assembly for electrical connectivity.

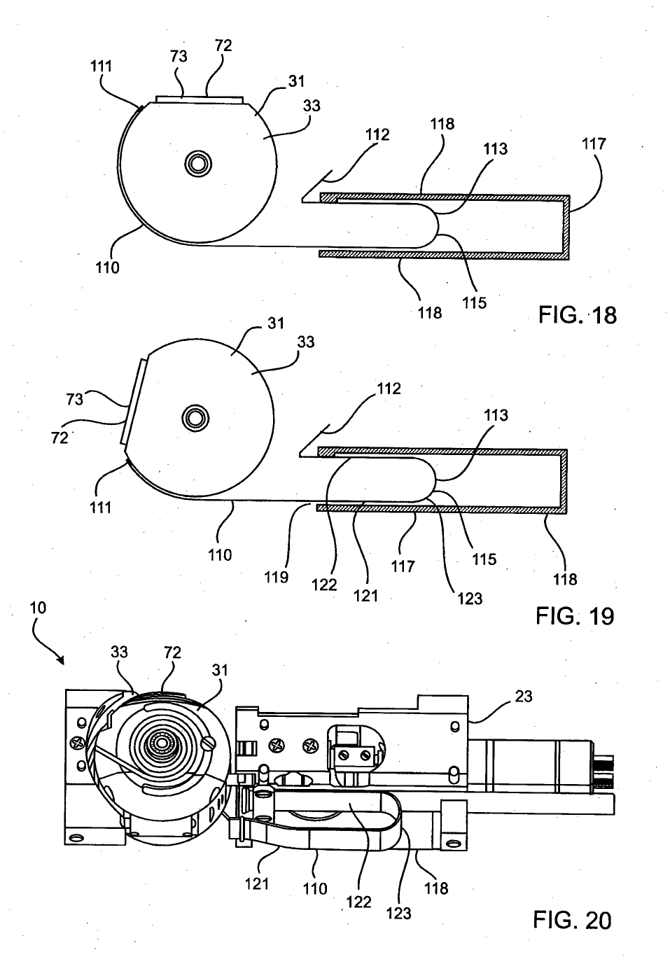

There is also a need for electrical connectivity between the indexing platform 33 and the base 23 which accommodates electronic circuitry for the surveying tool 10. For this purpose, a flexible connecting cable 110 extends between the indexing platform 33 and the electronic circuitry (not shown), with one end section 111 of the cable 110 connected to the indexing platform 33, the other end section 112 connected to the electronic circuitry, and the intermediate section 113 configured as a loop 115, as shown in FIGS. 18, 19 and 20. In the arrangement illustrated, the cable 110 comprises a flat multi-core cable. The loop 115 is accommodated in a cable receptacle 117 having two opposed sides 118 and an open end 119 through which the cable extends. The loop 115 comprises two straight sections 121, 122 and a turn section 123 extending between the two straight sections. The two straight sections 121, 122 are constrained and guided by the sides 118 of the cable receptacle 117, with straight section 121 being adapted to undergo translation motion, sliding along the adjacent side 118 of the cable receptacle 117 as the indexing platform 33 rotates. This accommodates relative movement between the indexing platform 33 and the electronic circuitry. As the straight section 121 of the cable 110 slides, the turn section 123 rolls within the cable receptacle 117 in unison with the translating straight section 121. The portions of the cable 110 constituting the straight sections 121, 122 and the turn section of course varies as the straight section translates and the turn section 123 rolls.

Such an arrangement provides a simple yet highly effective electrical connection between connectivity between the indexing platform 33 and the base 23, which is compact and which obviates the need for a conventional slip ring assembly for electrical connectivity. The loop 115 preferably has a relatively large radius of curvature to avoid adversely stressing the cable 110 and affecting its service life.

As previously described, it is necessary to align the indexing platform 33 prior to actuation of the indexing mechanism 70. Specifically, it is necessary to align the pitch of the indexing platform 33 prior to indexing so that the indexing plate 75 is presented correctly to the drive pin 87. The optical alignment system 130 is operable to sense correct alignment between the drive and driven portions 71, 72 for operative engagement therebetween, whereby the driven portion 72 can receive drive from the drive portion 71 to cause indexing of the sensor device about the indexing axis 4.

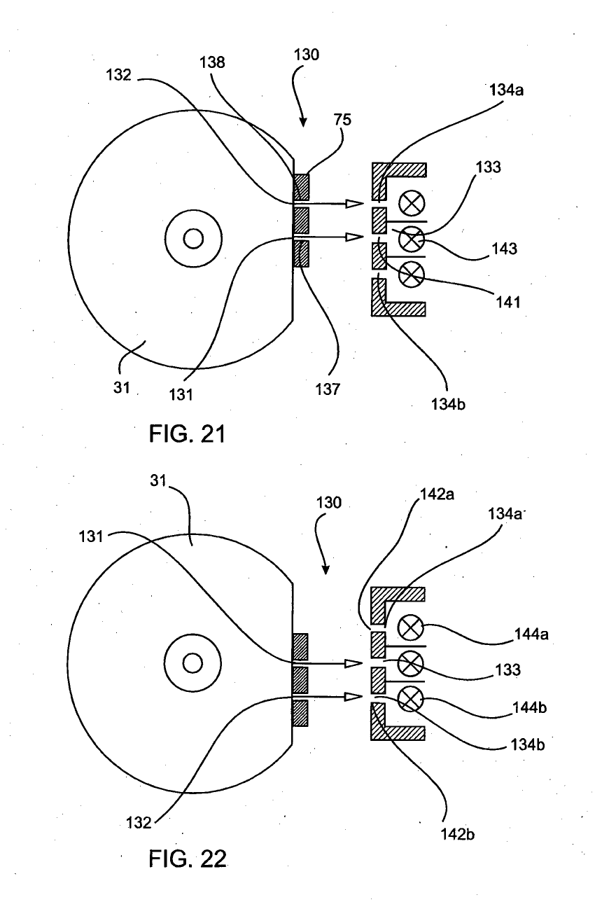

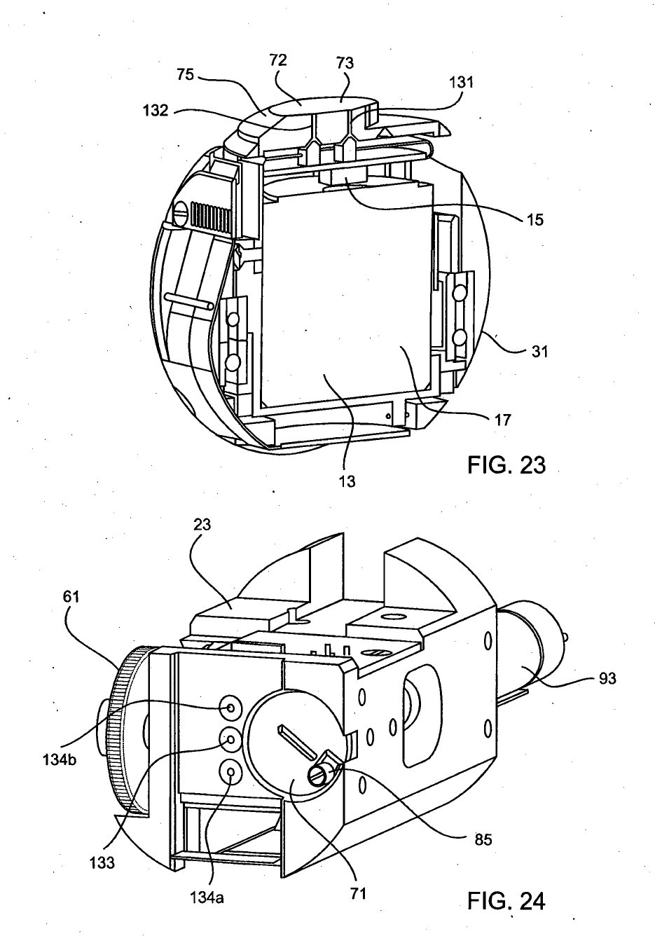

Referring now to FIGS. 21 and 22, the optical alignment system 130 comprises a first optical signal transmitter 131 and a first optical signal receiver 133 which cooperate to confirm that alignment is correct. The first optical signal transmitter 131 is adapted to generate and project a modulated beam of light from the indexing platform 33 in a direction perpendicular to the surface of the indexing plate 75 and parallel to the indexing axis 4. Specifically, the first optical signal transmitter 131 comprises a central aperture 137 in the indexing plate 75 and an optical emitting device (not shown) located behind the aperture 137 for emitting the modulated beam of light. The first optical signal receiver 133 comprises a corresponding aperture 141 and optical detector 143 mounted externally of the indexing platform 33, typically on the base 23, in such a way that the apertures 137, 141 align and the modulated beam is detected when the indexing plate 75 is in the correct position.

In this embodiment the optical alignment system 130 which is configured to also detect that the sensor device 17 has indexed correctly into the desired indexing position. As previously mentioned, there are two indexing positions for the sensor device 17, with the two indexing positions being 180 degrees apart.

In the arrangement illustrated, the optical alignment system 130 comprises a second optical signal transmitter 132 offset from the first optical signal transmitter 131. The second optical signal transmitter 132 comprises a second aperture 138 in the indexing plate 75 and an optical emitting device (not shown) located behind the aperture 138 for emitting the modulated beam of light.

The optical alignment system 130 further comprises one or more further optical signal receivers 134 offset from the first optical signal receiver 133. In the arrangement shown, there are two further optical signal receivers 134a, 134b on opposed sides of the first optical signal receiver 133. The further optical signal receivers 134a comprises a corresponding aperture 142a and optical detector 144a. The further optical signal receivers 134b comprises a corresponding aperture 142b and optical detector 144b.

With this arrangement, the first optical signal transmitter 131 and a first optical signal receiver 133 cooperate to provide confirmation of alignment of the pitch of the indexing platform 33 prior to indexing so that the indexing plate 75 is presented correctly to the drive pin 87. Further, the second optical signal transmitter 132 cooperates with the further optical signal receivers 134 to provide confirmation that the sensor device 17 has indexed correctly into the desired indexing position. As the two indexing positions are 180 degrees apart, further optical signal receiver 134a functions to monitor one indexing position and further optical signal receiver 134b functions to monitor the other indexing position. FIG. 21 illustrates the arrangement where the sensor device 17 is in the first indexing position, with second optical signal transmitter 132 cooperating with the further optical signal receivers 134a to provide confirmation that the sensor device 17 has indexed correctly into the first indexing position. Similarly, FIG. 22 illustrates the arrangement where the sensor device 17 is in the second indexing position, with second optical signal transmitter 132 cooperating with the further optical signal receivers 134b to provide confirmation that the sensor device 17 has indexed correctly into the second indexing position.

Because the gyroscope 13 and the accelerometer 15 are rigidly connected together, they undergo indexing in unison. In this way, the sensitive axes of the gyroscope 13 and the accelerometer 15 can be aligned to cancel systematic errors.

Operation of the borehole surveying tool 10 will now be described.

In performing a borehole surveying operation, the tool 10 is moved along the borehole, typically suspended from a wire line. At each location where a survey measurement is required, the tool 10 is stopped and then activated, and the survey process initiated. The survey process involves changing the roll angle of the housing 29, and then rotating the indexing platform 33 about the pitch axis 1 using the pitch drive mechanism 51, to move the respective planes of the sensitive axes of the gyroscope 13 and accelerometer 15 as required. Typically, the sensitive axes are moved into positions where they are aligned with respective horizontal planes. As the indexing platform 33 rotates, the cable 110 moves to accommodate relative movement between the indexing platform 33 and the electronic circuitry mounted on the base 23, thereby maintaining electrical connection between connectivity between the indexing platform 33 and the electronic circuitry, as previously described.

In this embodiment, the sensitive axes of the gyroscope 13 and the accelerometer 15 are required to be exactly level within respective horizontal planes. When the sensitive axes are level, a first measurement, or a set of first measurements, can then be taken. In order to reduce or cancel systematic errors, it is routine to index the gyroscope 13 and accelerometer 15 through 180 degrees to obtain a second measurement, or a set of second measurements. The first and second measurements are then processed in known manner to obtain a resultant measurement from which systematic errors have been reduced or cancelled. In order to index the sensor device 17 to take the second measurement, or set of second measurements, it is first necessary to rotate the indexing platform 33 about the pitch axis 1 using the pitch drive mechanism 51 to move the indexing head 73 towards the drive portion 71 into the position shown in FIGS. 4 to 7 and FIGS. 11 to 13. At this stage, the axis of rotation of the indexing plate 75 (which corresponds to the indexing axis 4 is parallel to the axis of rotation 91 of the drive shaft 89.

The optical alignment system 130 is used to ensure alignment of the pitch of the indexing platform 33 with respect to the drive pin 87, prior to operation of the indexing drive motor 93, as previously described.

Subsequent rotation of the drive shaft 89 under the action of the indexing drive motor 93 causes the drive pin 87 to move laterally through a circular path about the axis 91 in the direction corresponding to the direction of rotation of the drive shaft 89. The moving drive pin 87 interacts with the indexing plate 75 to cause it to rotate about its axis of rotation (which corresponds to the indexing axis 4). This causes the sensor device 17 to index about the indexing axis 4 through 180 degrees and assume the second indexing position. The electrical connection between the sensor device 17 and the indexing platform 33 is maintained by the flexible connecting cable 100 coiled about the indexing axis 4, as previously described.

Once the sensor device 17 has been indexed, the pitch drive mechanism 51 can be actuated to rotate the indexing platform 33 about the pitch axis 1 and restore the sensor device to its earlier position at which the second measurement, or set of second measurements, can then be taken.

Once the first and second measurements, or set of measurements, have been taken, the tool 10 can be deactivated and then moved to the next position within the borehole at which a further survey measurement is to be taken. When at the next position, the tool 10 is activated and the survey process initiated, as described before.

The procedure is continued until the survey has been completed.

In the embodiment described, the sensor device 17 comprises the two-axis gyroscope 13 and the two-axis accelerometer 15. The indexing process, when applied to the accelerometer, has the beneficial effect of cancelling its systematic errors, thereby allowing a low performance device to level the gyroscope sensing plane to a degree otherwise only achievable using a more capable and expensive accelerometer. Furthermore, the indexing process has the additional benefit of eliminating any errors in the alignment of the sensing axes between the gyroscope and the accelerometer.

It should be appreciated that the scope of the invention is not limited to the scope of the embodiment described.

Modifications and improvements may be made without departing from the scope of the invention.

Further, it should be appreciated that the invention may find application in apparatus, devices and mechanisms other than down hole surveying tools.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

1. A sensor device comprising a gyroscope and an accelerometer connected together and rotatable in unison about an axis perpendicular to two sensitive axes of the gyroscope and two sensitive axes of the accelerometer.

2. The sensor device according to claim 1 wherein the gyroscope comprises a two-axis gyroscope and the accelerometer comprises a two-axis accelerometer, with the respective sensitive axes perpendicular to the indexing axis.

3. A down hole surveying tool incorporating a sensor device according to claim 1.

4. A down hole surveying tool comprising a sensor device rotatable about an indexing axis, a base, a support for supporting the sensor device for rotation about the indexing axis, the support comprising a rotary mount supported on the base for rotation about a pitch axis transverse to the indexing axis, a pitch drive mechanism for selectively rotating the rotary mount about the pitch axis, and an indexing drive mechanism for indexing the sensor device about the indexing axis, the sensor device comprising a gyroscope and an accelerometer connected together and rotatable in unison, the indexing axis being perpendicular to two sensitive axes of the gyroscope and two sensitive axes of the accelerometer.

5. The down hole surveying tool according to claim 4 wherein the indexing drive mechanism comprises a drive portion and a driven portion, the drive portion being provided on the base and the driven portion being provided on the rotary mount and drivingly connected to the sensor device, the driven portion being movable into and out of engagement with the drive portion upon rotation of the rotary mount about the pitch axis, whereby when the driven portion is in engagement with the drive portion the driving portion can receive drive therefrom to cause indexing of the sensor device about the indexing axis.

6. A method of performing a down hole survey operation using a down hole surveying tool according to claim 4.

7. A method of performing a down hole survey operation comprising:
positioning a survey tool at a selected location within a borehole, the survey tool having a sensor device with at least two sensitive axes;
orienting the sensor device such that the two sensitive axes occupy a selected plane;
obtaining a measurement from the sensor device at the selected location;
moving the sensor device into an indexing position at which the sensor device can be indexed about an indexing axis perpendicular to the two sensitive axes;
returning the indexed sensor device to the position at which the two sensitive axes occupied the selected plane; and
obtaining a further measurement from the sensor device at the selected location.

8.-10. (canceled)
